(19) United States
(12) Patent Application Publication
(10) Pub. No.: US 2017/0120692 A1
(43) Pub. Date: May 4, 2017

(54) TREAD WITH CHANNELS ON THE EDGES OF SAME

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Benoit DURAND-GASSELIN, Ladoux, Clermont-Ferrand Cedex 9 (FR); Matthieu BONNAMOUR, Ladoux, Clermont-Ferrand Cedex 9 (FR)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 15/300,455

(22) PCT Filed: Mar. 27, 2015
(86) PCT No.: PCT/EP2015/056782

§ 371 Date: Sep. 29, 2016

(30) Foreign Application Priority Data
Mar. 31, 2014 (FR) 1452815

(51) Int. Cl. B60C 11/24; B60C 11/12; B60C 11/03; B60C 11/13

(52) U.S. Cl. CPC B60C 11/24; B60C 11/13; B60C 11/1281; B60C 11/0306; B60C 2011/0365

(57) ABSTRACT

The tread has circumferential grooves delimiting intermediate and edge parts and formed so as to be present at least until a tread wear limit is reached. The tread also having a tread surface with at least one tread wear indicator formed in a circumferential groove. The tread comprising on its edge regions a plurality of transverse cuts that have depths suited to be present down to the tread wear limit. Each transverse cut is formed of a first part opening onto the tread surface when new and extending towards the inside of the tread by a void part forming a channel of mean width greater than a mean width of the groove. The channel forms a new transverse groove after a predetermined amount of part wear. A cross section of each channel increases when progressing along the cut axially from the inside towards the outside of the tread.

### CROSS-REFERENCE TO RELATED APPLICATIONS

The present invention claims priority to PCT International Patent Application Serial No. PCT/EP2015/056782 filed Mar. 27, 2015 entitled “Tread With Channels On The Edges of Same,” which claims the benefit of FR Patent Application Serial No. 1452815 filed Mar. 31, 2014, the entire disclosures of the applications being considered part of the disclosure of this application and hereby incorporated by reference.

### BACKGROUND OF THE INVENTION

1. Field of the Invention

The present disclosure relates to a tread for a tire comprising several wearing layers, some of these wearing layers forming new grooves that open onto the tread surface of the tread.

2. Related Art

A tire tread extends circumferentially around the tire and acts as intermediary between the structure of the tire and the surface or roadway on which the tire is running. Contact between the tread and the roadway is in a contact patch. A tread comprises a tread pattern formed of a plurality of raised elements—ribs and/or blocks—separated from one another by grooves and/or sipes. These grooves and sipes form, on the tread surface, edge corners of benefit in obtaining grip performance, whether this be in terms of traction, braking or road holding under cornering.

One problem faced by a person skilled in the art is how to maintain tire performance as the tread of the tire wears.

Document WO2012/058171, published in 2012, is known and discloses a tread pattern comprising several wearing layers with, for each wearing layer, a void volume ratio that is specific and suited to each wearing layer. Specifically, if the void ratio when new is too high, while admittedly it is possible to have a void ratio after part-wear, there is then a loss of stiffness when new which may prove detrimental in terms of other performance aspects.

Moreover, a tread for a passenger vehicle tire has an external profile which is not a cylinder around the axis of rotation of the tire provided with this tread. This profile, when viewed in a plane containing the axis of rotation, is curvilinear and has more pronounced curvature in the axially external edge regions of the tread. In these regions, and because of this transverse profile, it is as if the wearing thickness of tread were reduced. The abovementioned document WO2012/058171 does not tackle this problem: specifically, as the tread wears, the volume available for the flow of water when driving in the wet is reduced, and all the more so with increasing proximity to the regions axially on the outside of the tread.

There is therefore a need to create a tread for a tire intended to be fitted to a passenger vehicle, which makes it possible to ensure performance that is lasting with wear while at the same time solving the problem described hereinabove.

### DEFINITIONS

The void ratio of a tread pattern is equal to the ratio between the surface area of the voids (grooves) delimited by the blocks and the total surface area (contact area of the blocks and surface area of the voids). A low void ratio indicates a high contact area of the blocks and a low surface area of voids between the blocks.

The void surface ratio of a tread pattern is equal to the ratio between the surface area of the voids (essentially formed by grooves) delimited by the raised elements (blocks, ribs) and the total surface area (contact area of the raised elements and surface area of the voids). A low void ratio indicates a high contact area of the tread and a low surface area of voids between the raised elements.

The void volume ratio of a tread pattern when new is equal to the ratio between the volume of the voids (formed notably by grooves, cavities) delimited by the raised elements (blocks, ribs) and the total volume of the tread comprising the volume of wearable material and the volume of the voids. A low void volume ratio indicates a low volume of voids in relation to the volume of the tread. For each wear level, a void volume can also be defined.

Equatorial plane: plane perpendicular to the axis of rotation and passing through the axially outermost points of the tire, this equatorial plane virtually dividing the tire into two substantially equal parts.

A block is a raised element formed on the tread and delimited by voids or grooves and comprising lateral walls and a contact face intended to come into contact with the roadway. This contact face has a geometric center defined as being the barycenter or center of gravity of the face.

A rib is a raised element formed on a tread, this element extending in the circumferential direction and making one circuit of the tire. A rib comprises two lateral walls and a contact face, the latter being intended to come into contact with the roadway during running.

A radial direction in this document refers to a direction which is perpendicular to the axis of rotation of the tire (this direction corresponds to the direction of the thickness of the tread).

A transverse or axial direction refers to a direction parallel to the axis of rotation of the tire.

A circumferential direction refers to a direction which is tangential to any circle centered on the axis of rotation. This direction is perpendicular both to the axial direction and to a radial direction.

Axially outwards means a direction oriented towards the outside of the internal cavity of the tire.

The total thickness E of a tread is measured, on the equatorial plane of the tire provided with this tread, between the tread surface and the radially outermost part of the crown reinforcement when new.

The usual running conditions of the tire or conditions of use are those defined by the E.T.R.T.O. standard; these conditions of use specify the reference inflation pressure corresponding to the load bearing capacity of the tire as indicated by its load rating and speed code. These conditions of use may also be referred to as “normal conditions” or “standard conditions”.

A tread wear indicator means a device that can be moulded with the tread and makes it easier for the user to gauge the wear of this tread. In general, a tread comprises several tread wear indicators each formed of a cusp of a height set by legislation and moulded into the grooves of this tread.

The contact patch in which the tire is in contact with the ground is created with the tire under static conditions; from this contact patch, a mean value for the length of the contact patch in the circumferential direction is calculated.

A cut refers generically to an opening made notably by moulding and corresponds to the space delimited by walls of material facing one another and separated from one another by a non-zero distance (referred to as the “width of the cut”). A cut may be either a groove or a sipe or even a combination of at least one groove with at least one sipe. It is precisely the distance separating the walls of material facing one another that differentiates a sipe from a groove; in the case of a sipe, this distance is suited to allowing at least partial contact of the walls delimiting the sipe at least in the contact patch in which the tire is in contact with the roadway. In the case of a groove, the walls delimiting this groove cannot come into contact with one another under usual running conditions.

### SUMMARY OF THE INVENTION AND ADVANTAGES

The present disclosure seeks both to improve the performance when new and to maintain this good performance after partial wear down to full wear.

To this end, the subject of the disclosure is a tread for a tire, this tread comprising at least two grooves of circumferential overall orientation delimiting intermediate parts and edge parts these edge parts axially delimiting the tread. These grooves of circumferential overall orientation are formed so as to be present at least until the tread wear limit is reached. This tread comprises a tread surface when new, this tread surface having an external transverse profile obtained as the intersection of the tread surface with a plane containing the axis of rotation of the tire, this curvilinear transverse profile generating a reduction in the thickness of wearable material on the edge regions of the tread.

This tread comprises at least one tread wear indicator formed in at least one circumferential groove to indicate the tread wear limit for this tread during running and as a result the user is able to replace the worn tire with a new tire.

Moreover, this tread comprises on its edge regions a plurality of cuts of transverse overall orientation and of depth suited to being present down to the tread wear limit. Each cut of transverse overall orientation is formed of a first part opening onto the tread surface when new, this first part having a mean width and being extended towards the inside of the tread by a void part forming a channel of mean width greater than the mean width of the first part, this channel comprising a bottom and being intended to form a new transverse groove after a predetermined amount of part wear.

This tread is such that the cross section of each channel, this cross section being measured between the bottom of this channel and at least a height equal to the height of the tread wear indicator, increases when progressing along the cut axially from the inside of the tread towards the outside of the tread.

Advantageously, this tread is such that each cut formed by a first part extended by a channel has a total cross section when new which is: either constant over the entire length of the cut, or increases when progressing axially towards the outside of the tread. The total cross section of a cut refers to the surface area of the cross section of this cut measured at various positions between its ends.

Each transverse cut opens axially to the outside of the tread, namely onto a lateral part of the tread, and may or may not open into a circumferential groove.

Advantageously, the maximum depth of each cut formed on the edge regions is equal to the maximum depth of the grooves of circumferential overall orientation.

The first part of each transverse cut formed on the edge regions may be formed by a sipe of which the delimiting walls are able to come into contact with one another as they enter the contact patch. This first part may also be a groove.

Advantageously, each transverse cut formed on the edge regions comprises an intermediate part making a progressive connection between the first part of the cut that opens onto the tread surface when new, and the channel that extends this first part inwards.

By virtue of this solution it is possible, even when the total thickness when new is reduced at the edges of the tread bearing in mind its curvilinear transverse profile, to maintain a satisfactory level of performance when running on a wet roadway when the tread wear reaches the legal tread wear limit.

Further features and advantages of the disclosure will become apparent from the description given hereinafter with reference to the attached drawings which, by way of nonlimiting examples, show embodiments of the subject matter of the disclosure.

### BRIEF DESCRIPTION OF THE FIGURES

FIG. 1 depicts a partial plan view of a surface of a tread;

FIG. 2 depicts a perspective view of an edge region of the tread shown in FIG. 1;

FIG. 3 shows a view in section on I-I of FIG. 1; and

FIG. 4 shows a view in section on II-II of FIG. 1.

### DETAILED DESCRIPTION OF THE ENABLING EMBODIMENT

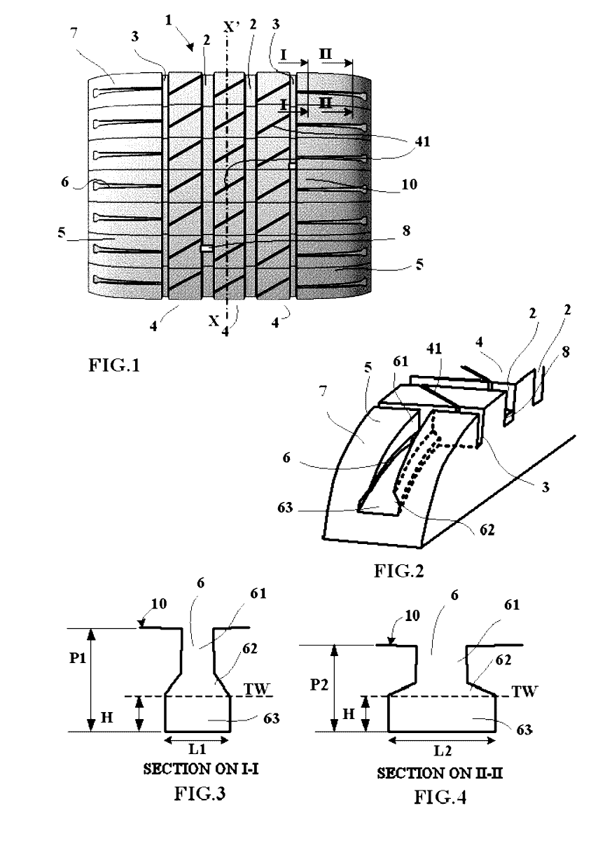

FIG. 1 depicts a partial plan view of a tread surface 10 of a tread 1. This FIG. 1 partially depicts a tread 1 intended to equip a tire of a passenger vehicle. This tread 1 comprises four circumferential grooves 2, 3 all having the same depth equal to 8 mm. Tread wear indicators are moulded into the bottom of at least one of these grooves. The depth of these grooves 2, 3 is such that, when tread wear reaches the tread wear limit set by the national regulations (the moulded tread wear indicators come into contact with the tread surface), these grooves have not completely disappeared and there is still the possibility of draining away any water that might be present on a roadway.

The two circumferential grooves 2 closest to the equatorial plane (indicated by a line XX′ in FIG. 1) have a mean width equal to 10 mm while the other two grooves 3 have a mean width equal to 8 mm.

These four grooves delimit three intermediate rows 4 and two edge rows 5 axially delimiting the tread 1. The intermediate rows 4 are provided with a plurality of oblique sipes 41 that close when they enter the contact patch.

On this tread and, more specifically, in the circumferential grooves, several tread wear indicators 8 are moulded all around the tread in order to allow the user easily to gauge the level of tire wear and assure himself that his tires have not yet reached the tread wear limit set by legislation. In this particular instance, the tread wear indicators 8 form a relief in the bottom of the grooves of a height equal to 1.6 mm. Accordingly, when the external surface of these indicators 8 comes into contact with the roadway, there is still enough depth in the circumferential grooves to ensure safe driving. At that moment, it of course becomes necessary for the user to replace this worn tire with a new tire.

Each edge row 5 comprises a plurality of transverse cuts 6, each transverse cut 6 opening onto the tread surface 10 and into a circumferential groove 3. Each transverse cut 6 in this particular instance comprises a groove 61 opening onto the tread surface 10 when new, this groove 61 being extended by an intermediate connecting part 62 of a width that can vary in the depth of the tread, this intermediate connecting part 62 ending in a channel 63, the width of which is greater than the width of the groove 61.

Given the external transverse profile of the tread when new (this profile 7 is visible in FIG. 2 which depicts a partial perspective view of an edge region 5) and given the internal reinforcing structure of a tire, it is clear that the wearable thickness at the edge of the tread is significantly reduced especially with increasing axial distance away from the equatorial midplane. If the performance of the tread 1 is to be maintained, notably in the edge regions 5 thereof, it is advantageous to construct the transverse cuts 6 in these regions according to the disclosure, namely by contriving for the cross section of each channel 63 to increase when progressing axially from the inside of the tire outwards, notably by increasing the mean width thereof.

Thus, following wear corresponding to the tread wear limit, the volume available for drainage in the transverse cuts (reduced to the channels) is not reduced when progressing towards the outside, but rather is increased in this particular instance.

FIG. 3 shows a view in section on I-I of FIG. 1. In this FIG. 3, it may be seen that a transverse cut 6 is formed of a groove 61 of constant width equal to 2.5 mm, extended towards the inside by a channel 63 of maximum width L1 equal to 5.5 mm, the groove 61 being connected to the channel 63 by an intermediate connecting part 62 having a width that can vary and is suited to connecting the groove 61 to the channel 63. The distance between the tread surface 10 when new and the bottom of the channel 63 is denoted P1 whereas the distance between the external surface of the tread wear indicator TW identified by the dotted line and the bottom of the channel is denoted H.

The cross section of the channel 63 remaining beyond the tread wear limit represents 9 mm². The total cross section of the cut when new is equal to 25 mm².

FIG. 4 shows a view in section on II-II of FIG. 1. The position of this section is situated axially on the outside of the position of the section shown in FIG. 3.

The distance between the tread surface 10 when new and the bottom of the channel 63 in this plane of section is denoted P2 whereas the distance between the external surface of the tread wear indicator TW identified by the dotted line and the bottom of the channel is denoted H.

In this FIG. 4, it may be seen that, in this plane of section, the transverse cut 6 has a cross section equal to what it had for the position corresponding to the section shown in FIG. 3, whereas the width of the groove 61 opening onto the tread surface when new has increased and is equal to 4.5 mm and the width L2 of the channel 63 remaining beyond the tread wear limit TW has increased in comparison with the width L1 of the channel considered in FIG. 3 so that the cross section of the channel remaining beyond the tread wear limit TW in this plane of section II-II is greater than it was in the plane of section I-I of FIG. 3.

In this plane of section, the cross section of channel remaining beyond the tread wear limit is equal to 12 mm² (the maximum width of the channel is equal to 7.5 mm).

In an alternative form that has not been shown here, the width of each groove opening onto the tread surface when new remains constant over the entire length of the transverse cut, only the width of the channel extending each groove varying by increasing.

In another alternative form that has not been depicted, the first part of the cut is formed of a sipe of which the walls are able to come at least partially into contact with one another in the contact patch. The walls of this sipe may of course be provided with means, such as reliefs, that collaborate with one another to limit relative movement.

Of course, the disclosure is not restricted to the examples described or depicted and various modifications can be made thereto without departing from the scope defined by the claims.

What is claimed is:

1. A tread (1) for a tire,
said tread having a tread wear limit signalled by at least one tread wear indicator and comprising at least two grooves (2, 3) of circumferential overall orientation delimiting intermediate parts (4) and edge parts (5),
said edge parts (5) axially delimiting said tread (1),
said grooves of circumferential overall orientation being formed so as to be present at least until said tread wear limit is reached,
said tread comprising a tread surface (10) when new,
said tread surface having an external transverse profile (7) obtained as the intersection of said tread surface with a plane containing the axis of rotation of said tire tyre,
said transverse profile generating a reduction in the thickness of wearable material on said edge parts (5) of said tread,
said tread comprising at least one tread wear indicator formed in a circumferential groove (2, 3) to indicate said tread wear limit for said tread during running,
said tread comprising on its said edge regions (5) a plurality of cuts (6) of transverse overall orientation and opening onto a lateral part of said tread,
each of said transverse cuts having a depth suited to being present down to the tread wear limit,
each of said cuts (6) of transverse overall orientation being formed of a first part (61) opening onto the tread surface (10) when new,
said first part (61) having a mean width and being extended towards an inside of said tread by a void part forming a channel (63) of mean width greater than the mean width of said first part (61),
said channel (63) being intended to form a new transverse groove after a predetermined amount of part wear,
each channel (63) having a cross section,
said cross section being measured between the bottom of this channel (63) and at least a height equal to the height of the tread wear indicator and increasing when progressing along said cut (6) axially from said inside of said tread towards an outside of said tread.

2. The tread (1) for a tire as set forth in to claim 1, wherein said cut (6) formed by said first part (61) extended by said channel (63) has a total cross section when new which is constant over an entire length of said cut (6).

3. The tread for a as set forth in claim 1, wherein said cut (6) formed by said first part (61) extended by said channel (63) has a total cross section when new which increases when progressing along said cut (6) axially from said inside of said tread towards said outside of said tread.

4. The tread for a tire as set forth in claim 1, wherein a maximum depth of each cut (6) formed on said edge regions (5) is equal to a maximum depth of said grooves (2, 3) of circumferential overall orientation.

5. The tread for a tire as set forth in claim 1, wherein said first part (61) of each transverse cut (6) formed on said edge regions (5) is formed by a sipe of which the delimiting walls are able to come into contact with one another as they enter the contact patch.

6. The tread for a tire as set forth in claim 1, wherein each transverse cut (6) formed on said edge regions (5) comprises an intermediate part (62) making a progressive connection between said first part (61) that opens onto said tread surface (10) when new, and wherein said channel (63) extends said first part (61) inwards.

7. The tread for a tire as set forth in claim 1, wherein said transverse cuts (6) formed on said edge regions (5) open into said circumferential grooves (2, 3).
